(19) United States
(12) Patent Application Publication
(10) Pub. No.: US 2008/0295129 A1
(43) Pub. Date: Nov. 27, 2008

(54) SYSTEM AND METHOD FOR INTERACTIVE VIDEO ADVERTISING

(76) Inventor: Steven Laut, Norco, CA (US)

Correspondence Address: Steven Laut, 3280 Kips Korner Road, Norco, CA, 92860, US

(21) Appl. No.: 11/751,493

(22) Filed: May 21, 2007

(51) Int. Cl. H04N 7/10

(52) U.S. Cl. 725/34

(57) ABSTRACT

A method and a system to provide association of a video with selectable display locations associated with objects, and display of an advertisement associated with a selected display location of the video.

### BACKGROUND OF THE INVENTION

1. Field of the Invention

Exemplary embodiments relate generally to the technical field of video and graphic display and, in one exemplary embodiment, to methods and systems of interactive advertising in video and graphics.

2. Description of the Related Art

Video programming is beginning to reach out to the Internet where programming used to be strictly shown on televised network channels. Advertising on televised programs consists of commercials that are played before, during and after televised programming. Therefore, the viewers of the televised shows do not have a choice of what commercials are displayed. And, the commercials shown consume a good portion of a video program playing time.

### SUMMARY

One embodiment is presented including a method for associating a video with a plurality of selectable display locations associated with a plurality of objects, selecting one of the plurality of selectable display locations, and displaying an advertisement associated with the selected display location.

Another embodiment presented includes selecting a display portion on a video playing on a computing device, the selected display portion being associated with an advertisement, and displaying the advertisement based on the selected display portion.

Still another embodiment presented includes a machine-accessible medium containing instructions that, when executed, cause a machine to: associate a video with a plurality of selectable locations associated with a plurality advertisements; display a video advertisement associated with a selected location upon receipt of a selection command.

### BRIEF DESCRIPTION OF THE DRAWINGS

Embodiments are illustrated by way of example and not by way of limitation in the figures of the accompanying drawings in which like references indicate similar elements. The features and advantages of the embodiments will become more apparent by describing in detail exemplary embodiments thereof with reference to the attached drawings in which:

FIG. 1 is a block diagram of a method of one embodiment;

FIG. 2 illustrates a video frame including selectable objects;

FIG. 3 illustrates an exemplary portion of a screen view of a video where the bubble being blown is a selectable object;

FIG. 4 illustrates user selectable items displayed on an exemplary screen;

FIG. 5 illustrates an embodiment where a character in a video is holding an object that is associated with a selectable portion of a screen or window;

FIG. 6 illustrates an exemplary display of advertisement information stored in a database; and

FIG. 7 illustrates a diagrammatic representation of a machine in the exemplary form of a computer system.

### DETAILED DESCRIPTION

A method and system for interactive advertising in graphics and video are described. In the following description, for purposes of explanation, numerous specific details are set forth in order to provide a thorough understanding of an exemplary embodiment of the present invention. It will be evident, however, to one skilled in the art that the present invention may be practiced without these specific details.

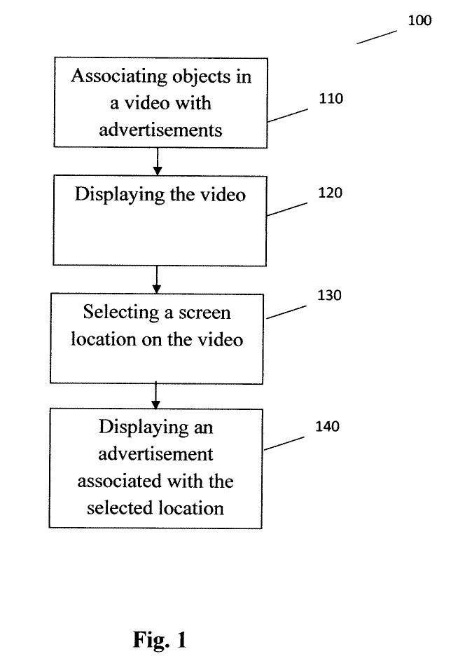

FIG. 1 is a block diagram of a process of an embodiment. Process 100 begins with block 110 where objects displayed in a video are associated with video advertisements. In one embodiment the video is a program similar to a televised program. In one embodiment the objects are products, logos, places or things displayed in a scene of the video. Based on the type of object, advertisements are associated with the object along with a pixel location of the object in specific frames of the video. In another embodiment, advertisements are associated with a portion of the video, such as a quadrant, a half, etc. In another embodiment, a predetermined number of frames are associated with a particular advertisement. In yet another embodiment, advertisements are selected from a database of advertisements in a round robin fashion. In still another embodiment, advertisements are selected based on an elapsed time period, such as first minute, first five minutes, last five minutes, etc.

In block 120, a user selects a video to be played. In one embodiment, once the user selects a video to be displayed, the video begins to be played. In one embodiment, the video selected by the user is selected from a database. In one embodiment, the selected advertisement is selected by a process based on user preferences, age, previous selections, etc. In this embodiment the videos stored in a database are the same videos with either different advertisements associated with objects or different products or services contained in the video.

In block 130, a user selects a portion of the video screen (e.g., uses a mouse to select a portion of a display). The portion selected by the user is associated with an advertisement. A process determines the advertisement associated with the selected portion from a database, and displays the advertisement in block 140.

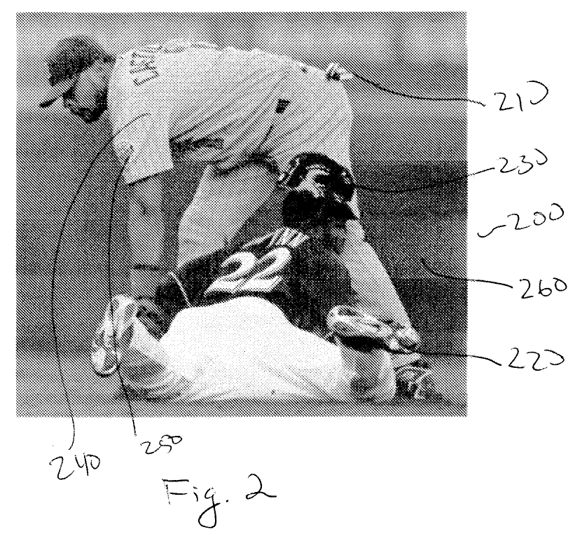

FIG. 2 illustrates an exemplary video frame 200 including selectable objects. Object 210 associates the portion of the video screen displaying gloves. The gloves 210 are associated with a video advertisement. The advertisement can be for the exact same gloves or another brand of gloves if there would not be any intellectual property infringement. Object 220 associates the portion of the screen displaying an athletic shoe. Object 230 associates the portion of the video screen displaying the hat. Object 240 associates the portion of the screen displaying a team jersey. Object 250 associates the portion of the screen displaying a team logo. The team logo object 250 can be associated with team specific advertising, such as ticket sales, memorabilia sales, clothing, etc. Object 260 is associated with the screen displaying a field. The portion of the screen associated with the field can be used for generic advertising or advertising associated with the stadium.

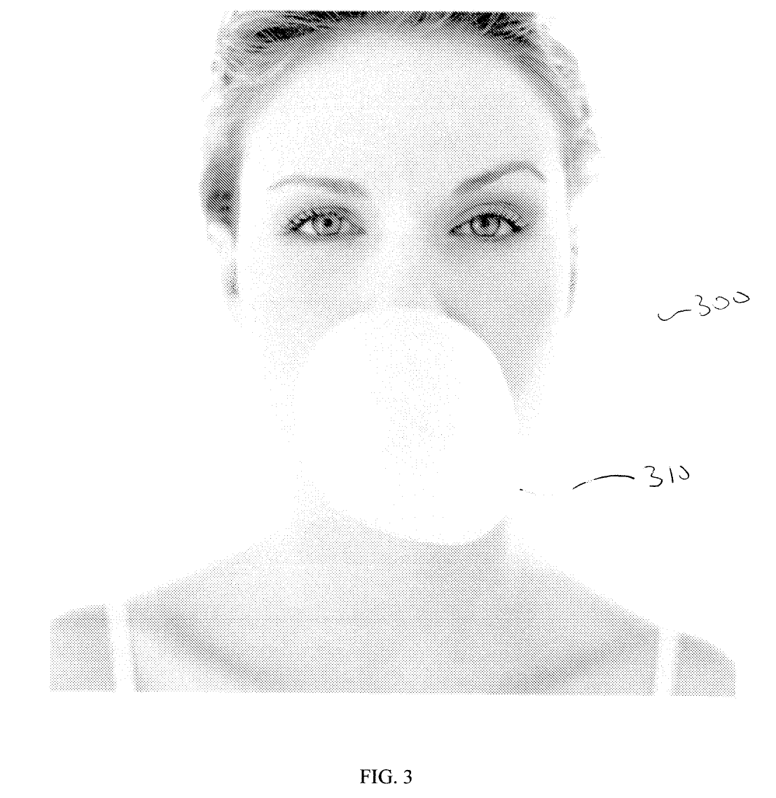

FIG. 3 illustrates an exemplary portion of a screen view of a video 300 where the bubble being blown 310 is selectable. In one embodiment, advertisements for specific goods or services are associated with generic objects in the video. For example, a character in the video (either cartoon, animation, or real person) can be holding a bottle of drinkable liquid without a label or description. The bottle can be associated with an advertisement for a particular beverage product or multiple beverage products to be displayed. In one embodiment, the bubble being blown 310 is highlighted to show users that the bubble 310 is selectable.

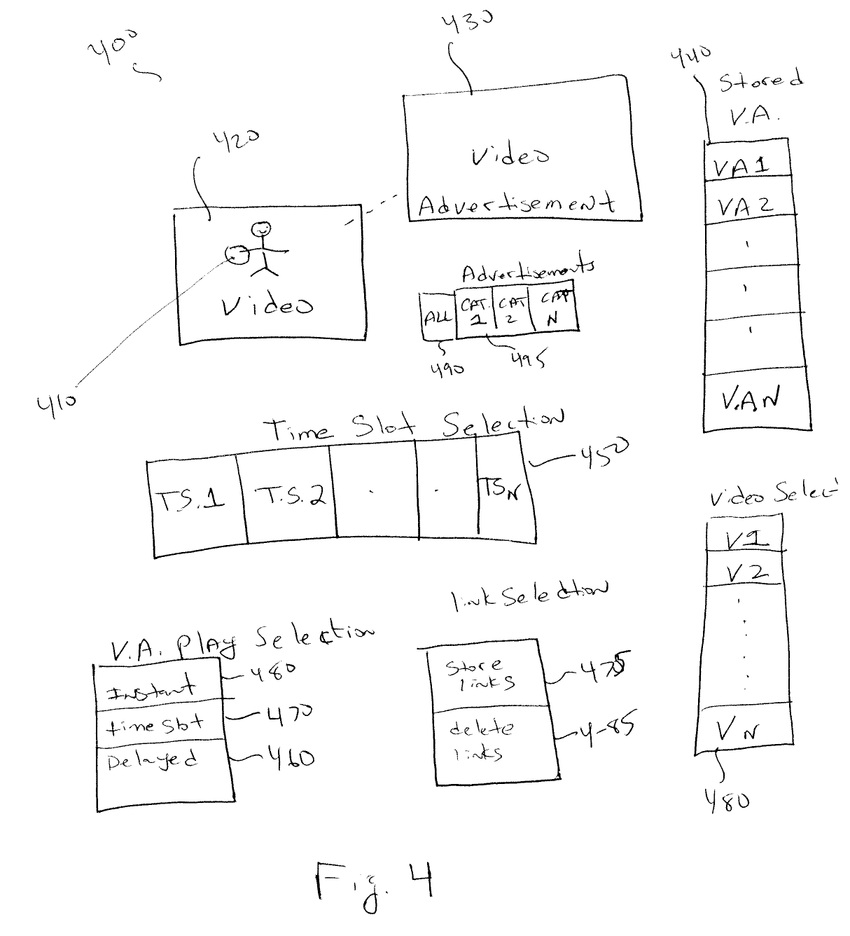

FIG. 4 illustrates user selectable items displayed on an exemplary screen. The video 420 is selected either from video select list 480, video screen shots displayed, or through a channel selection. In one embodiment, if a particular object or portion of the video is selected by a viewer with a pointing object (e.g., a mouse), remote control, voice command, etc., an advertisement is displayed. In one embodiment the advertisement is a video commercial. In another embodiment, the advertisement is a graphic display. As illustrated a character on video 420 is holding a selectable object 410. Once a user selects object 410, a video advertisement 430 is displayable. The user can select to display advertisements in a selected time slot chosen through time slot selection 470; delayed viewing through selection 460; or instant displaying through selection 480. If the user selects time slot displaying, the user selects the time slots to display the advertisement through selection 450. In one embodiment a user can select to store links to the advertisements through selection 475 or to delete links with selection 485.

In one embodiment designated time slots can be preselected for a user or a user can select a time slot for showing selected commercials associated with objects. In the case of time slot pre-selection, an advertiser can choose the time slot or a host (e.g., a website host or host of a network) may choose the time slot. If no commercials are selected, the video will continue playing. If objects are selected by users, the associated commercials will play during the designated time slots. As the video is prerecorded, this amounts to just pausing the video or not at the designated time slots. Nothing prevents other designated commercials from playing before the video starts or ends. The user can store the commercials to be played at a later date, whenever they want. This makes it better for a user since they choose whether to watch a commercial or not. In another embodiment, different objects are highlighted with designated color outlines to alert users that these objects are selectable. The objects can be highlighted for a predetermined time. In one embodiment different highlighting colors have different meanings associated with them. For example, coupon codes in a commercial can be one color; a new product can be another color; etc. In another embodiment, the object can be flashed or targeted with an overlay symbol. In one embodiment a processing tool is used to highlight objects to associate with advertisements. When the object is highlighted or outlined, the pixel locations are associated with a selected advertisement and stored in a database where the data is associated with a frame(s) or specific time or time period.

In one embodiment, an overlay screen that is invisible to a user is placed over the video that is playing. In this embodiment, the overlay video screen or window includes selectable portions where a user can select a portion of the screen, for example with a mouse pointer. In this embodiment, an object can be highlighted in the overlay screen or window. In another embodiment, multiple overlay windows can be used where each overlay window or screen covers a specific object associated with advertising. In still another embodiment, an overlay screen or window includes a plurality of portions that are each associated with specific frames, objects, advertisements, etc. In this embodiment, when a user selects a particular overlay screen or window portion, a process receives as input the particular overlay screen or window, time or frame information of the video, associated object and advertisement for the particular frame and overlay. This information allows an appropriate advertisement to be selected for display by a user for the object selected by the user.

In another embodiment, a shape of an object is used to search through frames of a video. In this embodiment, a process or application searches all the video frames for a specific shape of an object, for example a glass with a beverage in it. Known methods or artificial intelligence search programs can be implemented. When a positive identification is made, the frame number and or time associated with the frame number is recorded and stored in a database. A management user can enter the type of object, in this example, a beverage, and whether it is generic or specific (e.g., a name brand). The management user can select advertisements to be included in certain time slots, all frames where the object is displayed, etc. Multiple advertisements can be selected from different advertisers for generic objects. Additionally, some advertisers may have multiple advertisements for a same product or want different advertisements for similar products. In this embodiment, the advertiser may choose to rotate advertisements, base advertisements on user preferences or profiles, etc. In one embodiment, a tracking program can track the advertisements that a particular user views and select advertising to display for the user based on previous advertising views. For example, if a user already viewed a particular advertisement associated with a beverage, if the user selects the beverage again, the advertiser may want to show the user another product. In this fashion, a user can be informed of other products associated with the same advertiser.

In one embodiment, an advertiser may choose to select all overlays or portions of a video to associate with an advertisement. In this embodiment, no matter what object a user selects, the same advertiser has advertisements associated with the video objects. The advertiser can choose which advertisements are available to be selected for display to the users from an advertising database.

In one embodiment, a user can make a delayed selection 460 so that all objects selected while watching the video do not cause the associated advertisements to be displayed. In this embodiment, the object's picture or description is stored and a user can select the object to display the advertisements at a later time. In this embodiment, the viewer can watch the video uninterrupted by advertisements and choose objects that they are interested in for viewing later.

In one embodiment, when an object is selected, the video pauses and a character in the video appears in a video commercial for the product or an associated product with the object. In one embodiment, the character in the advertisement emanates from the character on the video as if a ghost is appearing. In this embodiment an actor/person or character appears to leave a body of the actor/person or character in the video upon launching of the advertisement and re-enters the body of the actor in the video upon ending of the advertisement. In another embodiment the advertising may play for any amount of time.

In one embodiment, objects that appear in a video may change position from frame to frame. In this embodiment, the frame number is associated with the object's location (i.e., the pixels that the object displaces) in the frame and an advertisement. In this embodiment, a database is used to store and associate the object's location, frame number and advertisement(s) to be displayed based on a user selecting the object while viewing the video.

In one embodiment, the objects may be used or worn by a character in the video. In one embodiment, the object can be a place shown in the video, such as a restaurant, a hotel, an amusement park, etc. In one embodiment the object can be a vehicle (e.g., a car, motorcycle, bicycle, airplane, boat, etc.

In one embodiment, the advertisements associated with the object can be selected based on a viewer's age, previous selected advertisements, profile (e.g., likes/dislikes, age, address, employment, gender, etc.). In this embodiment, a user enters information in a profile on a website. When the user logs on to the website, a program reads the profile information and targets advertisements associated with the different objects to be displayed in a video. When a user selects a video to play, a database associates advertisements with the objects based on the profile. In another embodiment, the previous selected objects and/or advertisements are stored for each user of a website. In this embodiment, when a user logs on a website, the previously stored information is used to target advertisements for the particular user. In this embodiment, the previously viewed advertisements can be used to select alternate advertisements for the user. In one embodiment, the advertisements for generic objects are shown to a user based on location of the user. In this embodiment, local advertisers can have advertisements viewed to users that live within a certain radius of the advertiser.

In one embodiment, when music is played during a video, a user can select to see an advertisement associated with the music. For example, an advertisement with information on a band's latest music for purchasing the music, tour dates, ticket purchase, etc. In one embodiment, a user can select a link to view advertisements associated with the music. In one embodiment, when credits of a video are displayed, an advertisement is associated with a band's or artist's credit. A user can select the credit and view an associated advertisement. In one embodiment, a user can select to view all advertisements associated with music in the video. In this embodiment the advertisements are listed where a user can select any of the listed advertisements. The list can be presented in a dropdown menu, a listing window, icons, etc.

In one embodiment, a user can select to view a list of all advertisements associated with objects in a video through selection 490. The user may also only select to display advertisements associated with a category 495, such as automotive, food, clothing, etc.

In one embodiment the advertisements can also have associated objects. A user can select the objects and view other advertisements or further information related to the original advertisement. In this embodiment, an advertisement can have objects relating to other products or services of the advertiser. In one embodiment the viewed advertisement one or more links. These links can be links to the advertiser's website, fill out forms for more information, a link to store the advertiser's link to a user's favorite links list, etc.

In one embodiment, different versions of a video contain different objects. In this embodiment, the videos are recorded with different objects for different advertisers. For example, one video can contain objects for a particular brand item and an alternate video can contain objects for a different brand item. In this embodiment, a video is selected based on the user's information, such as profile, location, age, etc.

In one embodiment, when a video selected for viewing is a live event, a user can select a portion of the video to see advertisements. In this embodiment, since the event is live, the objects shown in the video are not associated with advertisements. In this embodiment, different locations or portions of the viewing screen are associated with advertisements. In another embodiment, advertisements are selected based on associated times (e.g., first five minutes, next five minutes, etc.). In yet another embodiment, advertisements are ordered based on advertising costs. In this embodiment, the advertisements are displayed in order from highest advertising cost to lowest. A program tracks the number of selections a user makes and advertisements are displayed in numerical order. In this embodiment, the user's selection on the video screen prompts an advertisement to be displayed.

In one embodiment, a database is used to store the number of times and advertisement is viewed. In this embodiment, an advertiser is charged based on the number of times their respective advertisements are viewed. In one embodiment, to prevent fraud, multiple viewings of an advertisement in a predetermined time are not counted. In this embodiment, a user's identity, user name, location, etc. is used to determine if a same user is fraudulently selecting advertisements. In one embodiment a process that manipulates the database automatically reports the number of legitimate selections for a designated period and can create invoices, either electronically or printouts. In one embodiment an advertiser can elect to limit their expenses by capping their advertisement costs. In this embodiment, when the cap is met, the advertisement is no longer displayed or associated with a selected object. In this embodiment, another advertisement can now be associated with the object for playing by users.

In one embodiment the advertisement associated with an object is a video commercial. In this embodiment, the video commercial lasts a predetermined time period (e.g., 15 seconds, 20 seconds, 30 seconds, etc.). In one embodiment, once the video commercial starts to play, the video commercial will continue until it completes. In one embodiment, the video commercial cannot be terminated before it completes. In another embodiment, the video commercial can be terminated at anytime by a user.

In one embodiment, a user can review previously viewed advertisements. In this embodiment the advertisements that a user viewed (based on selected objects) are stored in a database. The previously viewed advertisements can be used to determine a viewer's likes/dislikes for future advertising selection for a particular user.

In one embodiment, different time slots throughout the video are designated for associated commercials. In one embodiment, the time slots are associated with a particular advertisement based on a fixed fee. In another embodiment, the time slots are associated with a particular advertisement based on an auction where the highest bidder obtains the rights to the designated time slot. In these embodiments, a user can select a portion of the video to select where the portion is not necessarily associated with an object. When a user decides to select a portion of the video the associated advertisement is either played or selected to be played at a designated time or whenever the user decides.

In another embodiment, the objects are associated with particular advertisements based on either an auction or a fixed fee. In this embodiment, an advertiser can either bid on an object to be associated with a particular advertisement or pay a fixed fee in order to associate their advertisement with an object in particular portions of a video.

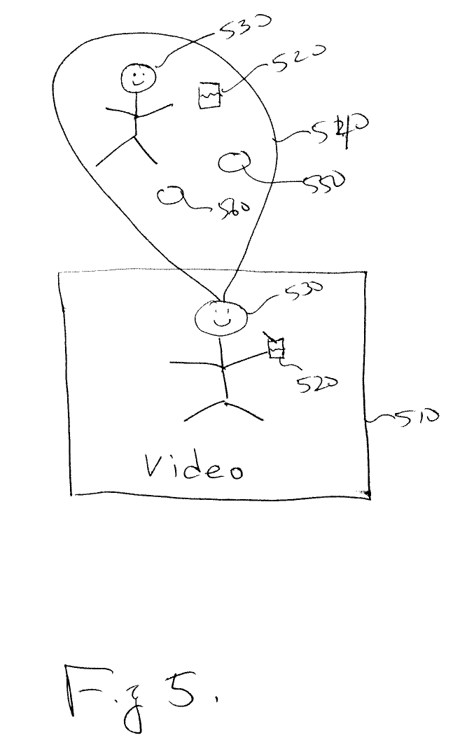

FIG. 5 illustrates an embodiment where a character 530 in a video 510 is holding an object 520, for example a drink, that is associated with a selectable portion of a screen or window. In this embodiment, when a user selects object 520, which is associated with an advertisement, a video advertisement 540 is displayed and video 510 is paused. In this embodiment, the character 530 may appear in the advertisement video 540 for object 520. In one embodiment, other objects 550 and 560 displayed in advertisement 540 are selectable and associated with other advertisements, links to other websites or channels, etc.

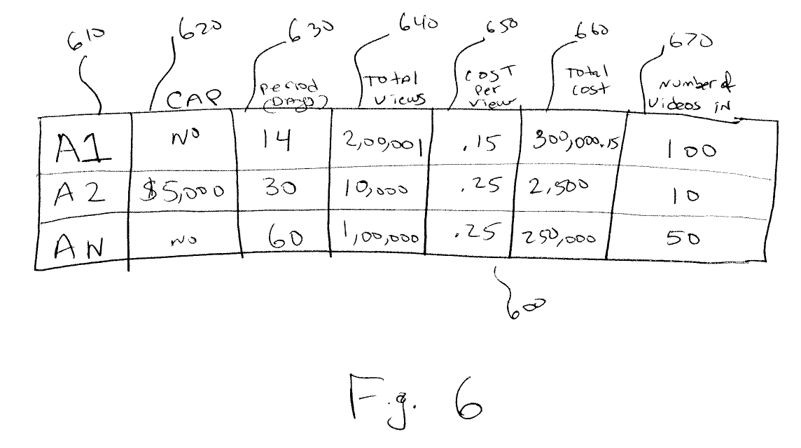

FIG. 6 illustrates an exemplary display of advertisement information stored in a database. In one embodiment a portion of the information is entered manually by a management person and other information is automatically updated. In one embodiment, the display 600 includes name of advertiser 610, advertisement cost cap 620, advertising period 630, total views 640, cost per view 650, total cost 660 and number of videos the advertisement is associated with objects 670. In one embodiment, other information can also be selected for display, such as time slot(s) associated with advertisement, number of advertisements viewed instantly, delayed, in selected time slots, etc. In one embodiment, user information is also stored in a database and available for display. In this embodiment, if users enter information before viewing the video, such as in a user profile, reports to advertisers indicating user information can be helpful in future advertising selections. For example, if more users in a certain age group are viewing the advertisement, alterations can be made to attract other demographics. Also, the type of videos that have more views can be used to determine how to proceed with future advertising campaigns. For example, if more advertising views occur in sports related videos, the advertiser may choose to only advertise in sports videos.

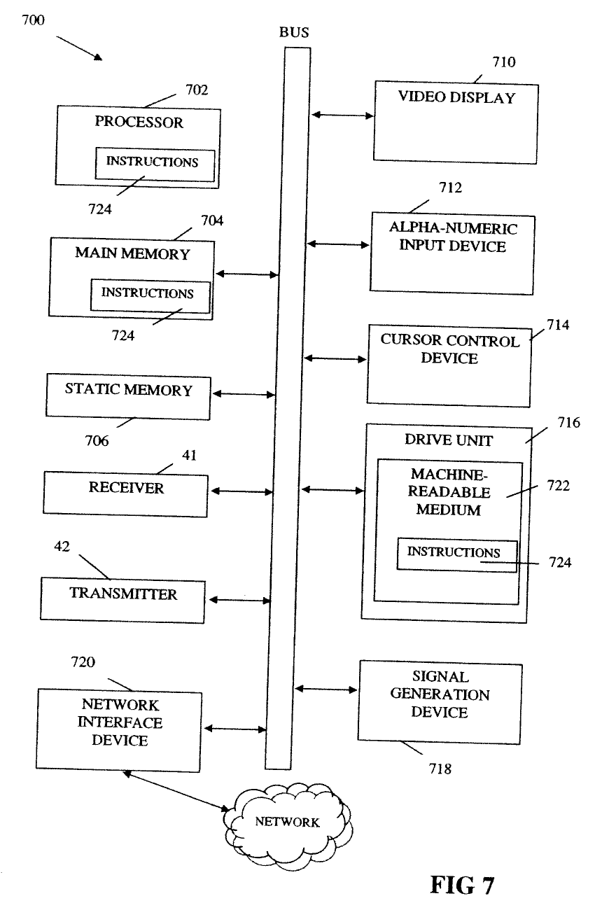

FIG. 7 shows a diagrammatic representation of a machine in the exemplary form of a computer system 700 within which a set of instructions, for causing the machine to perform any one or more of the methodologies discussed herein, may be executed. In various embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a PC, a tablet PC, a set-top box (SIB), a PDA, a cellular (or mobile) telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The software 724 may also reside, completely or at least partially, within the main memory 704 and/or within the processor 702 during execution thereof by the computer system 700, the main memory 704 and the processor 702 also constituting machine-readable media.

The software 724 may further be transmitted or received over a network 726 via the network interface device 720. In one embodiment, receiver 41 and transmitter 42 (see FIG. 1) are coupled to bus 708.

While the machine-readable medium 726 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present invention. The machine-readable medium includes any mechanism that provides (i.e., stores and/or transmits) information in a form readable by a machine (e.g., a computer, PDA, cellular telephone, etc.). For example, a machine-readable medium includes read-only memory (ROM); random-access memory (RAM); magnetic disk storage media; optical storage media; flash memory devices; biological electrical, mechanical systems; electrical, and optical. The device or machine-readable medium may include a micro-electromechanical system (MEMS), nanotechnology devices, organic, holographic, solid-state memory device and/or a rotating magnetic or optical disk. The device or machine-readable medium may be distributed when partitions of instructions have been separated into different machines, such as across an interconnection of computers or as different virtual machines.

Thus, a method and system provide interactive commercial selection that is personalized for a user. In the use of the embodiments, users can determine whether to view advertisements or not. This is distinguishable from typical television programming that includes commercials at designated time slots where the advertisers pay whether a viewer watches or changes channels or terminates a video because of the fore viewing of the advertisement. Additionally, the embodiments are appropriate for generic products included in videos that have already been recorded. Therefore, no specific product placement in a video is required. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Accordingly, the specification and drawings are to be regarded in an illustrative rather than a restrictive sense.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

What is claimed is:

1. A method comprising:
associating a video with a plurality of selectable display locations associated with a plurality of objects;
selecting one of the plurality of selectable display locations; and
displaying an advertisement associated with the selected display location.

2. The method of claim 1, further comprising:
associating specific product advertisements with generic products shown in the video.

3. The method of claim 1, wherein the video is paused when the one selectable object is selected.

4. The method of claim 1, wherein the advertisement is a video commercial.

5. The method of claim 1, wherein a character in the video appears in the advertisement.

6. The method of claim 2, wherein the video is one of a pre-recorded televised program and a live broadcast.

7. The method of claim 6, wherein the actor appears to leave a body of the actor in the video upon launching of the advertisement and re-enters the body of the actor in the video upon ending of the advertisement.

8. The method of claim 1, wherein the plurality of objects are one of products and services.

9. The method of claim 1, wherein the associated objects are associated based on one of time and a predetermined number of video frames.

10. The method of claim 1, further comprising:
overlaying the video with a window, wherein the overlay window includes portions associated with the plurality of objects.

11. The method of claim 1, wherein the advertisement includes one of a link for the one selected object and at least one additional selectable display location associated with at least one additional object.

12. The method of claim 3, wherein the video resumes after the advertisement is viewed.

13. The method of claim 1, wherein the plurality of selectable objects are part of a scene in the video.

14. The method of claim 1, further comprising:
associating the plurality of objects with advertisements based on one of an auction and a fixed fee.

15. The method of claim 1, further comprising preselecting a time slot to display the advertisement, wherein the time slot is one of selected by the user, selected by an advertiser and selected by a host.

16. A method comprising:
selecting a display portion on a video playing on a computing device, the selected display portion being associated with an advertisement; and
displaying the advertisement based on the selected display portion.

17. The method of claim 16, wherein the display portion is associated with an advertisement based on one of time and at least one predetermined video frame.

18. The method of claim 17, wherein the advertisement is a video commercial.

19. The method of claim 17, further comprising:
associating a plurality of pixel locations associated with the video with an associated advertisement;
storing the associated plurality of pixel locations; and
determining when at least one of the plurality of pixel locations is selected by a user.

20. The method of claim 16, further comprising:
highlighting an object on the video, wherein the highlighted object is associated with an advertisement.

21. The method of claim 16, wherein the selected display portion is associated with one of a product, a product handled by an actor in the video, a product worn by an actor in the video, a logo in the video, a place in the video, a business in the video and a service.

22. A machine-accessible medium containing instructions that, when executed, cause a machine to:
associate a video with a plurality of selectable locations associated with a plurality advertisements;
display a video advertisement associated with a selected location upon receipt of a selection command.
